(19) United States
(12) Patent Application Publication
(10) Pub. No.: US 2009/0127766 A1
(43) Pub. Date: May 21, 2009

(54) Medium transportation apparatus, image reading apparatus, and multifunction product

(75) Inventor: Yoshiaki Nakaishi, Tokyo (JP)

Correspondence Address: TAKUCHI & KUBOTERA, LLP, 200 Daingerfield Road, Suite 202, Alexandria, VA, 22314, US

(73) Assignee: Oki Data Corporation

(21) Appl. No.: 11/984,270

(22) Filed: Nov. 15, 2007

(51) Int. Cl. B65H 5/00; B41F 17/00

(52) U.S. Cl. 271/3.01; 270/1.01

(57) ABSTRACT

A medium transportation apparatus is provided with a medium placing unit having a placing surface for placing a medium. The medium placing unit includes a first flat surface portion and a second flat surface portion on the placing surface. The second flat surface portion is formed on an upstream side with respect to the first flat surface portion in a medium transportation direction. The first flat surface portion and the second flat surface portion are situated on different planes.

### BACKGROUND OF THE INVENTION AND RELATED ART STATEMENT

The present invention relates to a medium transportation apparatus, an image reading apparatus, and a multifunction product. Further, the present invention relates to an image forming apparatus such as a copier and a MFP (Multi-Function Product) using the medium transportation apparatus.

Conventionally, a medium transportation apparatus has been widely used in an image forming apparatus or a scanner for transporting a plurality of media one by one. The image forming apparatus includes a copier, a printer, a facsimile, or a multifunction product having functions of a copier, a printer, and a facsimile.

Patent Reference 1 has disclosed a medium transportation apparatus. In the medium transportation apparatus, a sheet supply tray normally has a flat shape, so that media to be loaded are easily aligned and placed in the sheet supply tray. Patent Reference: Japanese Patent Publication No. 2006-33325 In the sheet supply tray having a flat shape, a holding member of a sheet guide is provided for correcting a curl of a medium. In this case, it is possible to correct only a portion of the curl where the holding member is provided. Further, it is difficult to constantly correct a curl when the number of media varies. When a curl is not corrected properly, the medium tends to be transported unaligned, thereby causing such problems as oblique feeding, multiple feeding, or mis-feeding.

In view of the problems described above, an object of the present invention is to provide an image reading apparatus and a multifunction product, in which a sheet supply tray is provided with a unit for correcting a curl of a medium, so that the medium is securely transported one by one, thereby accurately reading an image recorded on the medium.

Further objects and advantages of the invention will be apparent from the following description of the invention.

### SUMMARY OF THE INVENTION

In order to attain the objects described above, according to the present invention, a medium transportation apparatus is provided with a medium placing unit having a placing surface for placing a medium. The placing surface includes a first flat surface portion and a second flat surface portion on the placing surface. The second flat surface portion is formed on an upstream side with respect to the first flat surface portion in a medium transportation direction. The first flat surface portion and the second flat surface portion are situated on different planes.

In the configuration described above, the first flat surface and the second flat surface of the placing surface are situated on the different planes. Accordingly, when a medium is placed on the placing surface of the sheet supply tray, an edge portion of the medium is curved in a gravity direction with its own weight, thereby correcting a curl of the medium.

In the medium transportation apparatus of the present invention, when media are placed in the sheet supply tray, the media are neatly aligned in a width direction thereof. Accordingly, it is possible to transport the medium without oblique feeding, multiple feeding, or mis-feeding, thereby accurately reading an image recorded on the medium.

### BRIEF DESCRIPTION OF THE DRAWINGS

FIG. 1 is a sectional view showing an image printing apparatus and an image reading apparatus according to a first embodiment of the present invention;

FIG. 2 is a perspective view showing a sheet supply tray according to the first embodiment of the present invention;

FIG. 3 is a perspective view showing a backside of the sheet supply tray according to the first embodiment of the present invention;

FIG. 4 is a perspective view showing a copier with the image reading apparatus according to the first embodiment of the present invention;

FIG. 5 is a view showing an operation of placing a curled medium in the sheet supply tray according to the first embodiment of the present invention;

FIG. 6 is a view showing an example of the sheet supply tray with a curved surface portion having an upward convex shape according to the first embodiment of the present invention;

FIG. 7 is a perspective view showing a sheet supply tray according to a second embodiment of the present invention;

FIG. 8 is a perspective view showing the sheet supply tray according to the second embodiment of the present invention;

FIG. 9 is a perspective view showing a backside of the sheet supply tray according to the second embodiment of the present invention;

FIG. 10 is a view showing a hinge unit according to the second embodiment of the present invention;

FIG. 11 explains an operation of placing a curled medium in the sheet supply tray according to the second embodiment of the present invention;

FIG. 12 is a view showing an operation of placing a curled medium in the sheet supply tray according to the second embodiment of the present invention;

FIG. 13 is a perspective view showing a sheet supply tray according to a third embodiment of the present invention; and

FIG. 14 is a view showing an operation of placing a curled medium in the sheet supply tray according to the third embodiment of the present invention.

### DETAILED DESCRIPTION OF THE PREFERRED EMBODIMENTS

Hereunder, embodiments of the present invention will be explained with reference to the accompanying drawings.

### First Embodiment

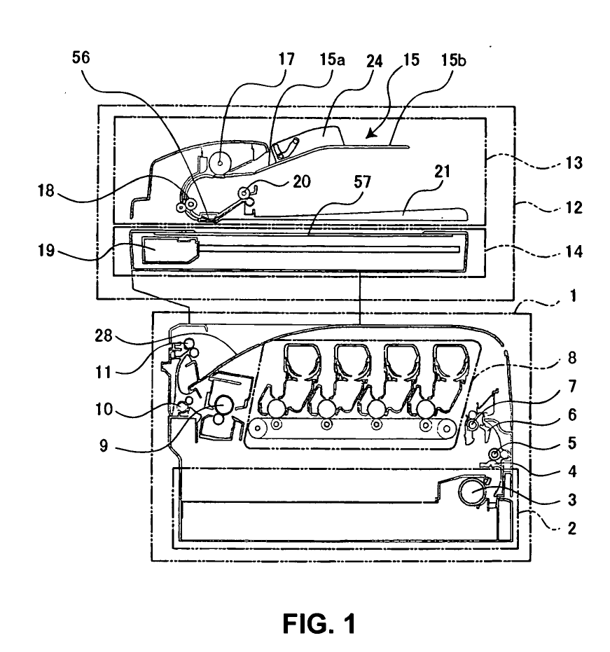

Hereunder, a first embodiment of the present invention will be explained with reference to the accompanying drawings. FIG. 1 is a sectional view showing an image printing apparatus 1 and an image reading apparatus 12 according to the first embodiment.

The image printing apparatus 1 comprises a sheet supply tray 2; a sheet supply roller 3; sensors 4 and 6; transportation rollers 5 and 7; an image forming unit 8; a fixing unit 9; and discharge rollers 10 and 11. The sheet supply roller 3 feeds a medium or sheet one by one from the sheet supply tray 2. The sensors 4 and 6 detect the sheet passing therethrough. The image forming unit 8 has an image drum and a transfer roller for forming an image on the sheet. The fixing unit 9 fixes the image formed in the image forming unit 8 onto the sheet. The discharge rollers 10 and 11 feed the sheet with the image from the image printing apparatus 1 to a discharge tray 28.

The image reading apparatus 12 comprises a medium transportation apparatus 13 and a flat head scanner 14 having an image reading sensor 19. The medium transportation apparatus 13 comprises a sheet supply tray 15; a pair of guiding units 16 and 24; a sheet supply roller 17; a transportation roller 18; and a discharge roller 20. The sheet supply tray 15 has a curved surface portion near a center of a medium placing surface thereof. The guiding units 16 and 24 regulate both ends of the medium in a width direction thereof. The sheet supply roller 17 feeds the medium one by one. The discharge roller 20 discharges the medium to a discharge tray 21 after reading an image.

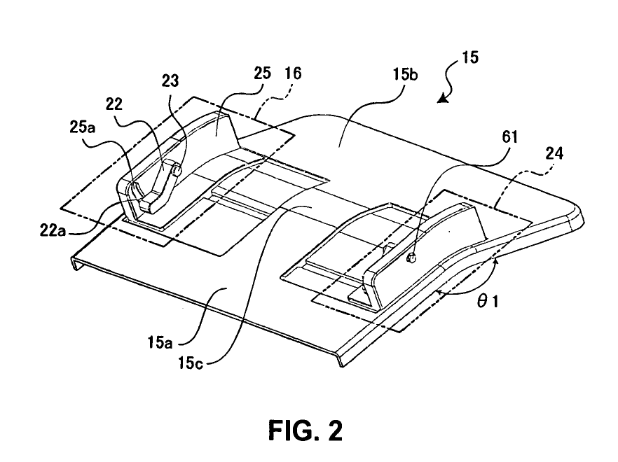

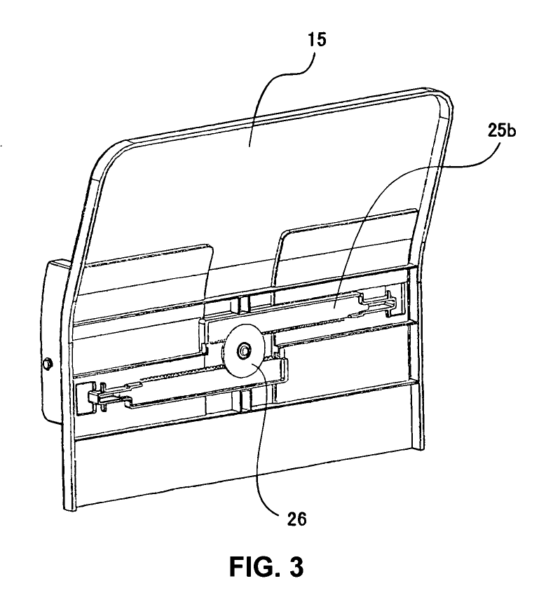

A configuration of the sheet supply tray 15 will be explained in more detail referring to FIGS. 2 and 3. The sheet supply tray 15 has a first flat surface portion 15a; a second flat surface portion 15b; and a curved surface portion 15c. The first flat surface portion 15a is situated on a downstream side in a medium transportation direction. The second flat surface portion 15b is formed on an upstream side of the first flat surface 15a in the medium transportation direction. The curved surface portion 15c is formed between the first flat surface portion 15a and the second flat surface portion 15b.

In the embodiment, the sheet supply tray 15 has an upwardly convex shape. Further, the first flat surface portion 15a is inclined with respect to a horizontal direction. Accordingly, the sheet supply roller 17 can smoothly transport the medium on the sheet supply tray 15 one by one.

Each of the guiding units 16 and 24 is arranged symmetrically with respect to a center position in the medium transportation direction near the center of the medium placing surface of the sheet supply tray 15. The guiding units 16 and 24 regulate a width of the medium.

The guiding unit 16 comprises a guide 25; a groove 25a formed in the guide 25; a holding member 22; a protrusion 22a; a posting pin 23; and an E-ring 61. The holding member 22 holds down the medium from a top to a bottom thereof in a thickness direction thereof. The protrusion 22a is a positioning protrusion for determining a height position. The guiding units 16 and 24 have an identical configuration. Accordingly, the guiding unit 24 is provided with the components of the guiding unit 16 at symmetrical positions.

The guiding unit 16 will be explained in more detail below. The guide 25 has a curved surface extending along a curved surface portion 15c of the sheet supply tray 15. The guiding unit 16 is disposed at least at the curved surface portion 15c for smoothly guiding the medium at the curved surface portion 15c where the medium tends to be curved. When the medium is curved, a curved portion of the medium has higher rigidity. Accordingly, when the medium is guided at a curved portion thereof, it is possible to easily guide the medium. The curved surface portion 15c has front and back portions connected to flat portions, so that the flat portions form an angle θ₁. The angle θ₁ is preferably an obtuse angle (90° <θ₁<180°). When the angle θ₁ is 120°, it is possible to remove a curl of the medium most efficiently.

When the angle θ₁ is equal to or smaller than 90° (θ₁≦90°), the medium may slip out of the sheet supply tray 15. When the angle θ₁is equal to 180° (θ₁=180°), it is difficult to correct the curl of the medium. When the angle θ₁ is greater than 180° (θ₁>180°); that is, when the guiding unit 16 has a downward convex shape, a rear edge side of the medium (an upstream side in the medium transportation direction) is lifted to curb the medium with the curved surface portion 15c as a boundary. That is, the rear edge of the medium extends with respect to an approximate vertical direction. Accordingly, the medium is trailed down to bend, and the rear end and the front end of the medium are close to each other, thereby making it difficult to feed the medium. Further, the front end of the medium tends to be lifted upward with respect to the sheet supply tray 15.

As shown in FIG. 3, the guide 25 has a rack gear 25b for engaging a pinion gear 26. The pinion gear 26 is supported to be rotatable on a boss portion provided in a backside of the sheet supply tray 15. Accordingly, the guiding units 16 and 24 are movable only in opposite directions with each other with respect to a center therebetween.

In the embodiment, the posting pin 23 engages the E-ring 61 to fix an edge of the holding member 22. The holding member 22 is rotatable by its own weight around the posting pin 23. A rotatable edge portion or the other edge of the holding member 22 is provided with the protrusion 22a. The protrusion 22a is a positioning protrusion to determine a height position and fits into the groove 25a of the guide 25. A diameter of the protrusion 22a is smaller than the groove 25a. Accordingly, the protrusion 22a is freely movable within the groove 25a.

In the embodiment, the groove 25a serves as a stopper of the protrusion 22a. The stopper is activated at a position in which the holding member 22 contacts with the medium when the medium is placed. A lower limit of the media is approximately five sheets in a case that a weight of the medium is 60 g/m². An upper limit is a maximum load depending on a medium specification of the medium transportation apparatus 13. For example, the maximum load may be approximately 50 sheets in a case that a weight of the medium is 105 g/m².

A position of the stopper mentioned above is assumed to be a position in which the curled media are corrected. Accordingly, the position is determined according to a thickness of the brand new media without a curl.

In the embodiment, the holding member 22 is provided on a downstream side in the medium transportation direction so as to hold the curl of the front end of the medium. When the sheet supply roller 17 presses against the medium with a press force of 350 gf, the holding member 22 needs to press against the medium with a press strength of 50 gf. Further, a holding member 29 is provided in the guiding unit 24a for pressing the medium, so that a total press force of the holding member 29 and the holding member 22 becomes 100 gf. It is arranged that the total press force of the holding member 29 and the holding member 22 is always smaller than the press force of the sheet supply roller 17.

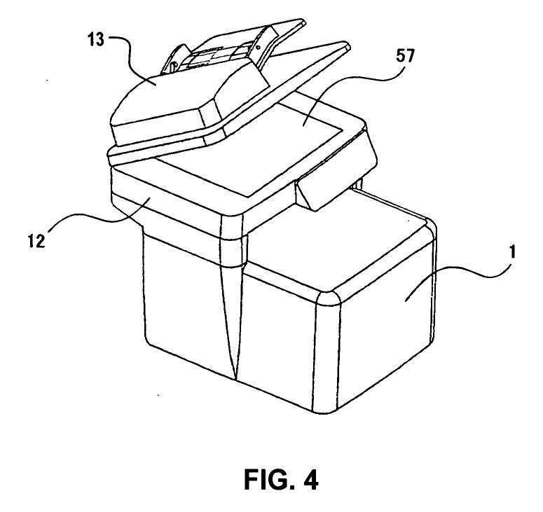

FIG. 4 is a perspective view showing a copier with the image reading apparatus according to the first embodiment of the present invention. The image reading apparatus 12 having the medium transportation apparatus 13 described above is attached to an upper portion of the image printing apparatus 1 in use.

An operation of the image printing apparatus 1 and the image reading apparatus 12 according to the first embodiment of the present invention will be explained next. First, the sheet supply roller 3 pulls out a sheet placed in the sheet supply tray 2. Then, the transportation rollers 5 and 7 feed the sheet to the image forming unit 8.

After the toner image is transferred to the sheet at the image forming unit 8, the sheet is fed to the fixing unit 9. A heater and a pressure roller fix toner onto the sheet. Finally, the discharge rollers 10 and 11 discharge the sheet to the discharge tray 28, thereby completing an operation of forming an image.

When the medium transportation apparatus 13 is used to read an image on the medium, the sheet supply roller 17 feeds the medium placed in the sheet supply tray 15. Then, the transportation roller 18 feeds the medium to an image reading portion 56, so that the image reading sensor 19 reads the image. After the image is read, the discharge roller 20 feeds the medium to the discharge tray 21.

When the flat head scanner 14 is used to read an image on the medium, the image reading sensor 19 reads the image on the medium placed on a glass surface 57. Image data read by the image reading sensor 19 are transferred to the image forming unit 8 to start an operation of the image printing apparatus 1.

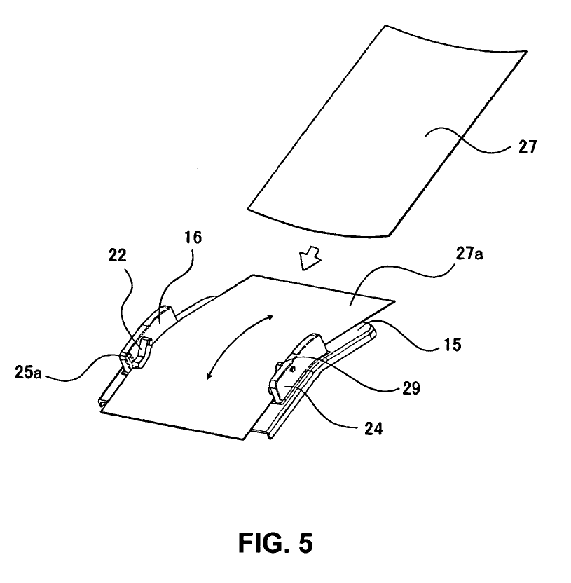

With reference to FIG. 5, an operation of placing a curled medium to the sheet supply tray 15 will be explained next.

In the embodiment, it is assumed that a medium 27 has a curl with a downward convex shape. When the medium 27 has a curl with a downward convex shape, right and left edges of the medium 27 are lifted with respect to a center portion thereof in the medium transportation direction. In general, when the medium 27 has a curl with a downward convex shape, the curl tends to be large and is prone to oblique feeding, multiple feeding, or mis-feeding.

On the other hand, when the medium 27 has a curl with an upward convex shape, a center portion of the medium 27 is lifted with respect to right and left edges thereof in the medium transportation direction. Accordingly, the convex portion of the medium receives gravity to suppress the curl of the medium. However, when the medium 27 has a curl with an upward convex shape, the curl tends to shift to right and left sides of the medium, thereby making it difficult to suppress the curl of the medium.

When the medium 27a is placed on the sheet supply tray 15, the holding members 22 and 29 hold the medium 27a by their own weight to reduce the curl of the medium 27a. The medium 27a is, by its own weight, placed in a shape curved along the curved surface portions of the sheet supply tray 15 and the guiding units 16 and 24, thereby correcting the curl.

Further, the holding members 22 and 29 prevent the front end of the medium 27a from lifting. That is, the holding members 22 and 29 always hold the edge portion of the medium 27a situated on a downstream side in the medium transportation direction, thereby reducing the curl of the medium 27a. Further, the edge portion of the medium situated on a downstream side in the medium transportation direction bows downward in a gravity direction by its own weight, thereby correcting the curl.

When the medium 27a is transported, the holding members 22 and 29 always hold the medium 27a by their own weight. After the medium 27a is completely transported, the holding members 22 and 29 are to rest at a stopper position of the groove 25a.

As described above, the sheet supply tray 15 and the guiding units 16 and 24 have the curved surface portions. Accordingly, when the medium with the curl curved laterally or longitudinally is placed, it is possible to provide the medium with an upper convex curl along the curved surface portions of the sheet supply tray. As a result, the medium has a smaller amount of the curl at the front end and both sides through a correction force of the upward convex curl.

When the medium is curled along the curved surface of the sheet supply tray, the curved surface portion of the medium has a large reaction force against a force of the guiding member for regulating a width direction of the medium. Accordingly, when the guide 25 holds the curved surface portion of the medium, it is easy to align the width of the medium as compared with a case when the medium is flat.

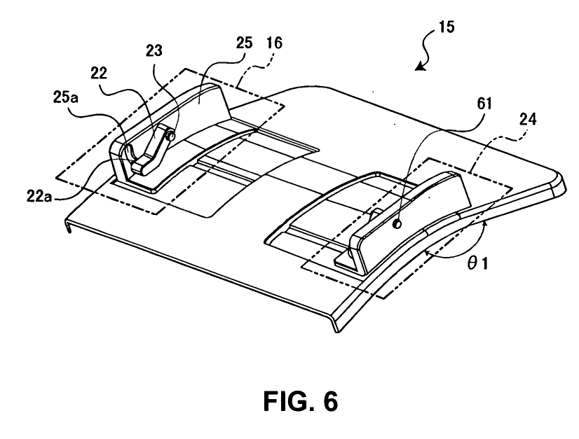

In the embodiment, the curved surface portion is provided between the first flat surface portion and the second flat surface portion, so that a part of the placing surface has the curved surface. Alternatively, as shown in FIG. 6, an entire placing surface of the sheet supply tray may have a curved surface portion having an upward convex shape.

### Second Embodiment

A second embodiment of the present invention will be explained next. In the second embodiment, a medium transportation apparatus has a configuration similar to that in the first embodiment. Accordingly, only differences from the first embodiment will be explained.

In the embodiment, a sheet supply tray 101 has trays 31 and 30 and hinge units 32 and 33. The tray 31 is a first flat surface portion situated on a downstream side in the medium transportation direction. The tray 30 is a second flat surface portion situated on an upstream side with respect to the first flat surface portion 31 in the medium transportation direction. The hinge units 32 and 33 adjust an angle formed by the first flat surface 31 and the second flat surface 30.

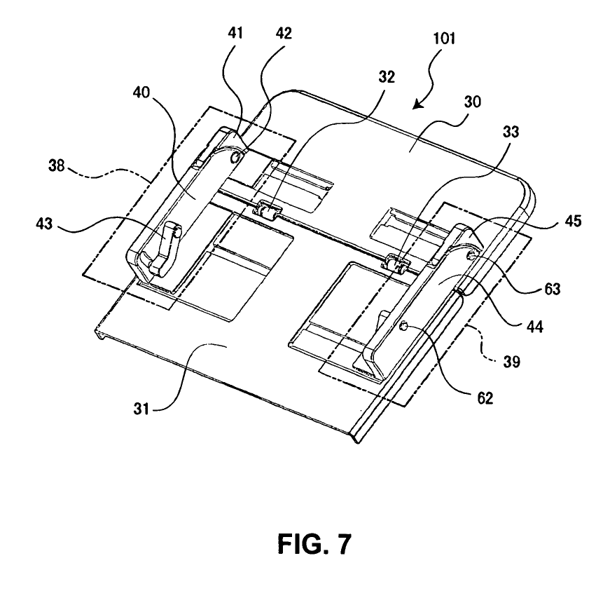

As shown in FIG. 7, the sheet supply tray 101 is divided into the trays 31 and 30. Further, guiding units 38 and 39 are attached to the trays 30 and 31 to be slidable in a perpendicular direction with respect to the medium transportation direction. The guiding unit 38 is divided into guides 40 and 41. Further, the guiding unit 39 is divided into guides 44 and 45.

In the embodiment, the guiding units 38 and 39 have an identical configuration, and only the guiding unit 38 will be explained in more detail. The guiding unit 38 has the guides 40 and 41, a posting pin 42, and an E-ring 63.

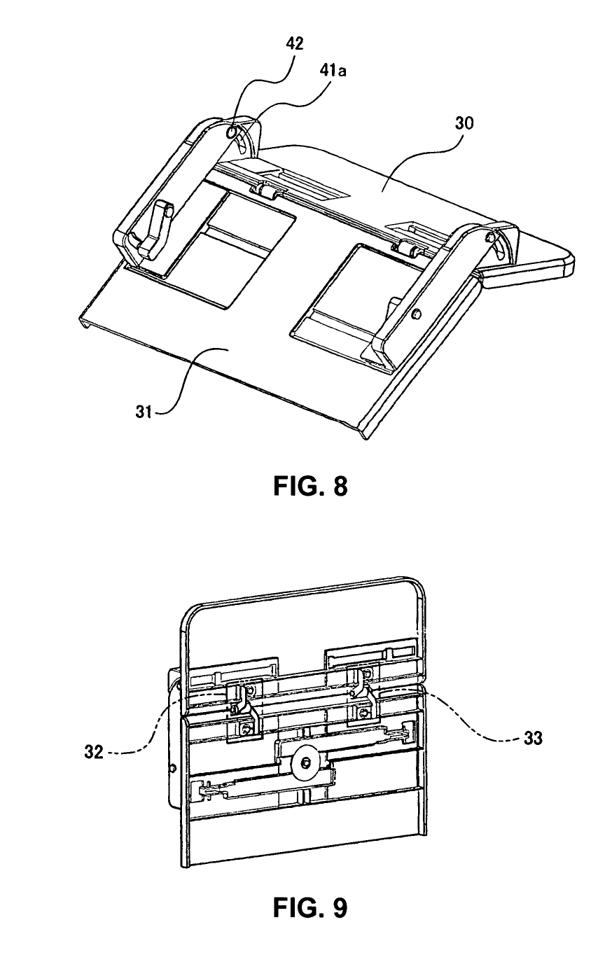

As shown in FIG. 8, the posting pin 42 is fitted into a groove 41a of the guide 41 and the posting pin 42 engages the E-ring 63, so that the guides 40 and 41 are connected. It should be noted that the guiding units 38 and 39 have an identical configuration. Accordingly, the components of the guiding unit 39 are disposed on the guiding unit 38 at symmetrical positions.

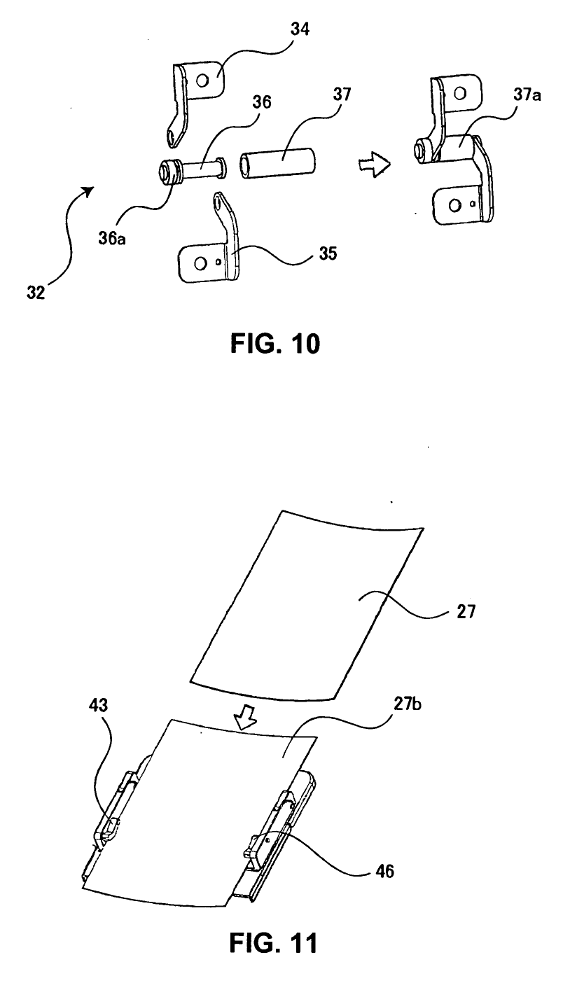

As shown in FIG. 9, the trays 31 and 30 are connected and fixed with the hinge units 32 and 33. The hinge units 32 and 33 have a similar shape. FIG. 10 is a view showing the hinge units 32 and 33 according to the second embodiment of the present invention.

In the embodiment, the hinge units 32 and 33 have an identical configuration, and only the hinge unit 32 will be explained in more detail. The hinge unit 32 comprises sheet metals 34 and 35, a posting pin 36, and a spring 37. The sheet metal 34 is fixed to a groove 36a of the posting pin 36, while the sheet metal 35 is rotatable around the posting pin 36. A spring 37a is sandwiched between the sheet metals 34 and 35 for applying an urging force to receiving surfaces of the sheet metals 34 and 35.

In the embodiment, the spring 37a is fixed only through the urging force, so that the spring 37a is freely rotatable. When the spring 37a has a larger urging force, the sheet metals 34 and 35 rotate at a lower speed, thereby adjusting an angle therebetween.

With the configuration described, the tray 30 and the guide 41 are rotatable around the posing pin 36. A rotation angle of the tray 30 and the guide 41 is from 0° to 90°. That is, an angle formed by the tray 30 and the tray 31 is from 180° to 90°. When the rotation angle is 0° and the angle formed by the tray 30 and 31 is 180°, the sheet supply tray 101 is flat. When the rotation angle is 90° and the angle formed by the tray 30 and 31 is 90°, the sheet supply tray 101 has an upwardly convex shape. While the tray 30 and the guide 41 rotate within the angle range, the posting pin 42 is freely movable within the groove 41a.

FIG. 11 is a perspective view showing the curled medium 27 placed in the sheet supply tray 101 when the sheet supply tray 101 is in a state shown in FIG. 7; that is, when the rotation angle of the tray 30 is 0°. After the curled medium 27 is placed in the sheet supply tray 101, holding members 43 and 46 reduce the curl of the medium 27b. However, the curl of the medium 27b may not be completely corrected.

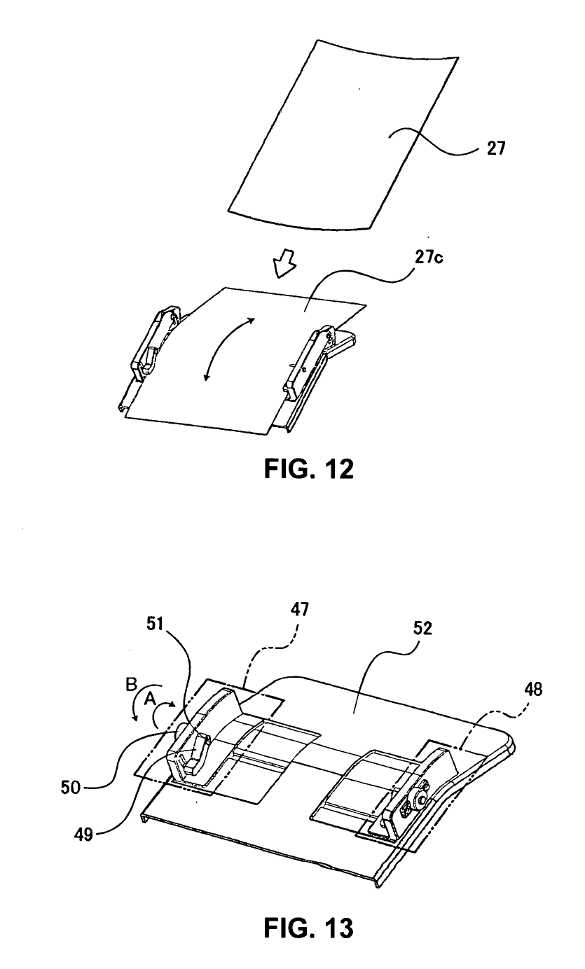

FIG. 12 is a perspective view showing the curled medium 27 placed in the sheet supply tray 101 in a state shown the FIG. 8. After the curled medium 27 is placed in the sheet supply tray 101, the medium 27c is curled in an upward convex shape along a bent portion of the sheet supply tray 101, and the holding members 43 and 46 prevent the front end of the medium 27c from lifting.

As described above, in the embodiment, the tray 30 and the guides 41 and 45 are rotatable. Accordingly, it is possible to adjust the angles of the tray 30 and the guides 41 and 45 according to an amount of the curl, thereby effectively correcting the curl of the medium.

In the first embodiment, the curl of the medium is corrected in an upwardly convex shape regardless of an amount of the curl of the medium. In an actual case, when the medium has a curl with a small amount, it is not necessary to correct the curl. In the second embodiment, when the medium has a curl with a small amount, the tray 30 is placed flat with respect to the tray 31, so that only the holding members 43 and 46 hold the curl. When the medium has a curl with a large amount, the angle of the tray 30 is adjusted to form the bent portion, so that the medium may be corrected to have a curl with an upward convex shape.

### Third Embodiment

A third embodiment of the present invention will be explained next. In the third embodiment, a medium transportation apparatus has a configuration similar to that in the first embodiment. Accordingly, only differences from the first embodiment will be explained.

In the embodiment, a guiding unit 47 has a holding member 49, a one-way hinge 50, and a posting pin 51. The holding member 49 holds the medium from top to down with respect to a thickness direction thereof. The one-way hinge 50 generates a load torque in one direction and becomes idle with no load in another direction. It should be noted that the guiding units 47 and 48 have an identical configuration. Accordingly, the components of the guiding unit 47 are disposed on the guiding unit 48 at symmetrical positions.

In the embodiment, the guiding unit 47 and 48 have an identical configuration, and only the guiding unit 47 will be explained in more detail. As shown in FIG. 13, the posting pin 51 is fitted into the one-way hinge 50 and fixed with an E-ring (not shown), so that one end portion of the holding member 49 is fixed. The holding member 49 is rotatable around the posting pin 51.

In the embodiment, the one-way hinge 50 generates a constant load torque with respect to a rotation in a direction A, while the one-way hinge 50 becomes idle with respect to a rotation in a direction B. The constant load torque is set to, for example, 0.2 N.m for correcting the curled medium to a flat shape.

When the load torque is small, the curl of the medium may push back the holding member 49. Accordingly, the medium may remain to be curled. When the load torque is large, the curl of the medium may be completely removed. However, when the medium is placed, a resistance of the holding member 49 is increased, thereby reducing operability.

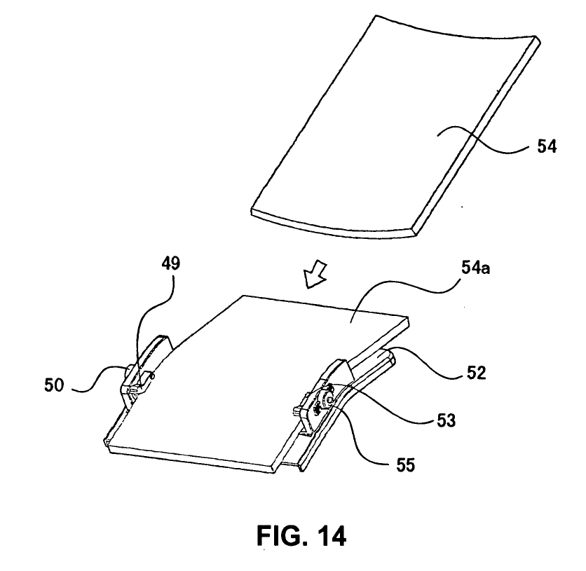

FIG. 14 is a perspective view showing a sheet supply tray 52 when a few dozens of curled media 54 are placed therein. When the media 54 are placed in the sheet supply tray 52, the holding member 49 and a holding member 53 apply a constant load torque on a front end of the media 54. Accordingly, the curl of the distal of the media 54 is held securely while the media 54 are placed in the sheet supply tray 52. Further, when the media 54a are fed, the holding members 49 and 53 always hold the media 54a by their own weight.

As described above, the holding members 49 and 53 apply a constant load torque, so that the curl of the distal of the medium is held securely regardless of an amount of the curl of the medium.

In the first and the second embodiments, the force to push back the curl of the medium when the medium is placed is the same as the force to hold the medium when the medium is fed (own weight). Accordingly, the holding members push back the curl of the medium with a relatively weak force. When the pushing force is increased, the holding force is also increased, thereby making it difficult to transport the medium.

In the third embodiment, the holding members 49 and 53 apply a constant load torque to the force to push back the curl of the medium, and the force to hold the medium is controlled by its own weight. Accordingly, the force to push back the curl of the medium may be increased.

The disclosure of Japanese Patent Application No. 2006-255998, filed on Sep. 21, 2006, is incorporated in the application by reference.

While the invention has been explained with reference to the specific embodiments of the invention, the explanation is illustrative and the invention is limited only by the appended claims.

What is claimed is:

1. A medium transportation apparatus, comprising:
a medium placing unit having a placing surface for placing a medium, said placing surface including a first flat surface portion and a second flat surface portion, said second flat surface portion being formed on an upstream side with respect to the first flat surface portion in a medium transportation direction, said first flat surface portion and said second flat surface portion being situated on different planes.

2. The medium transportation apparatus according to claim 1, wherein said medium placing unit further includes a curved surface portion disposed between the first flat surface portion and the second flat surface portion.

3. The medium transportation apparatus according to claim 1, wherein said medium placing unit further includes an angle adjusting unit disposed between the first flat surface portion and the second flat surface portion.

4. The medium transportation apparatus according to claim 1, wherein said first flat surface portion and said second flat surface portion are arranged so that the first flat surface portion forms an obtuse angle relative to the second flat surface portion.

5. The medium transportation apparatus according to claim 1, wherein said medium placing unit further includes a regulating unit disposed between the first flat surface portion and the second flat surface portion for regulating a medium in a width direction thereof.

6. The medium transportation apparatus according to claim 2, wherein said medium placing unit further includes a regulating unit disposed at least at the curved surface portion.

7. The medium transportation apparatus according to claim 6, wherein said regulating unit has a curved shape extending along the curved surface portion.

8. The medium transportation apparatus according to claim 3, wherein said medium placing unit further includes a regulating unit disposed between the first flat surface portion and the second flat surface portion for regulating a medium in a width direction thereof, said regulating unit being foldable according to an angle adjusted with the angle adjusting unit.

9. The medium transportation apparatus according to claim 5, wherein said regulating unit includes a holding member for pressing the medium downward in a thickness direction of the medium.

10. An image reading apparatus comprising the medium transportation apparatus according to claim 1.

11. A multifunction product comprising the medium transportation apparatus according to claim 1.
